(19) United States
(12) Patent Application Publication
(10) Pub. No.: US 2013/0146528 A1
(43) Pub. Date: Jun. 13, 2013

(54) FILTER ELEMENT FOR FILTERING FLUIDS

(71) Applicants: Volker Grobe, Weimar-Tiefurt (DE); Uwe Fries, Jena (DE)

(72) Inventors: Volker Grobe, Weimar-Tiefurt (DE); Uwe Fries, Jena (DE)

(21) Appl. No.: 13/261,570

(22) PCT Filed: Jul. 22, 2011
(86) PCT No.: PCT/EP2011/003686

§ 371 Date: Feb. 22, 2013

(30) Foreign Application Priority Data
Jul. 22, 2010 (DE) 10 2010 031 843.4

(51) Int. Cl. B01D 29/21

(52) U.S. Cl. CPC B01D 29/21
USPC 210/485

(57) ABSTRACT

The invention relates to a filter element for filtering fluids, comprising a flat support structure which forms the wall of a support tube (1) which surrounds the exterior and/or interior of a filter medium and has through-flow apertures (5) forming a perforation pattern (3), at least some of the through-flow apertures (5) having a substantially polygonal basic cross-section. The filter clement is characterized in that the polygonal basic cross-section is in each case determined by a plurality of side lines (13) and a plurality of imaginary corners (6) defined in each case by side lines (13) extending in pairs towards one another. In the region of the imaginary corners (6), the two corresponding side lines (13) are connected to one another by a curved line (11).

The invention relates to a filter element for filtering fluids, comprising a flat support structure which forms the wall of a support tube which surrounds the exterior and/or the interior of a filter medium and has through-flow apertures forming a perforation pattern, with at least some of the through-flow apertures having a substantially polygonal base cross section.

A filter element of this type is known, for example, from U.S. Pat. No. 5,783,067. In this prior art filter element, the fluid passageways are formed in the support tube as rounded elongated perforations, each of which has two side lines, which extend parallel to each other, and two curved lines, which connect the side lines together. The passage apertures, which are designed as elongated perforations, are aligned in such a way that they extend in the radial direction along the support tube.

In order to operate such filter devices that are used, for example, in hydraulic systems for filtering hydraulic fluids or in other systems for filtering fuels, lubricants, or other operating media, good performance of the filter elements that are used is the key criterion. In this case, the essential aspects are a pressure-tight support of the filter media against the acting flow forces, a feature that requires that the respective support structures exhibit high mechanical strength and that this support structure generate a minimum amount of flow resistance.

In order to satisfy these contradictory requirements in the best possible way, the prior art proposes to form perforation patterns with round perforations. In order to achieve the desired low values of flow resistance, the perforations have to be arranged in a suitable dense packing, as a result of which weak areas of material are produced between the perforations, and these narrow areas of material form weak spots in the structure, so that no acceptable compromise between structural strength and fluid permeability can be reached.

With respect to this problem, the object of the present invention is to provide a filter element that is provided with a support structure, which is characterized by high mechanical strength and at the same time good fluid permeability.

The invention achieves this object by means of a filter element having the features specified in claim 1 in its entirety.

According to the characterizing part of claim 1, an essential feature of the invention lies in the fact that the polygonal base cross section is defined in each instance by a plurality of side lines and a plurality of imaginary corners, which are defined in each instance by side lines that extend in pairs toward one another; and that in the region of the imaginary corners the two corresponding side lines are connected to one another by a curved line. The curved lines, of which the number corresponds to the number of corners or the number of side lines of the polygonal base cross section, enable a material relief when tension or force is introduced. The inventive shape results in a material relief at the narrow areas or the weak spots in the structure during application of stress by the flow forces.

In comparison to a round hole shape, a polygonal shape of the apertures makes it possible to achieve a larger open surface at a packing density of the pattern that produces the same minimal spacing between adjacent apertures and, thus, comparable material weak spots, so that the result is a lower flow resistance. The insensitivity of the material to notches is enhanced because of the fact that, furthermore, the through-flow apertures in the corner regions are defined by a curved line; and, hence, the side lines do not meet in such a way as to form impact points that form sharp corners. In addition, it is easier to produce apertures with rounded corners, for example, in the course of hole punching, than it is to produce corners with sharp edges.

It is especially advantageous to provide rectangular, in particular square through-flow apertures in the base cross section.

In order to reach an optimal compromise between structural strength and fluid permeability, the arrangement can be configured in such a way that the through-flow apertures form a perforation pattern, in which the through-flow apertures are arranged in straight lines and columns, and the through-flow apertures of lines and columns are in alignment with each other.

In this context, it can be especially advantageous to provide a regular perforation pattern with through-flow apertures that are arranged in the lines and columns in such a way that they are spaced evenly apart.

A particularly good compromise between structural strength and fluid permeability can be reached with through-flow apertures having a square base cross section, when the ratio between the side length and the distance from the center of adjacent through-flow apertures is about 3:5.

If the filter elements are not disproportionately large, the support structure can form a one-piece support tube that substantially surrounds the entire exterior and/or the interior of a cylindrical filter material.

On the other hand, in the case of filter elements that exhibit especially large dimensions, a support tube that surrounds the exterior of the cylindrical filter material can also be made from a winding consisting of one or more support structure members in strip form.

The invention is explained in detail below with reference to the drawings. Referring to the drawings:

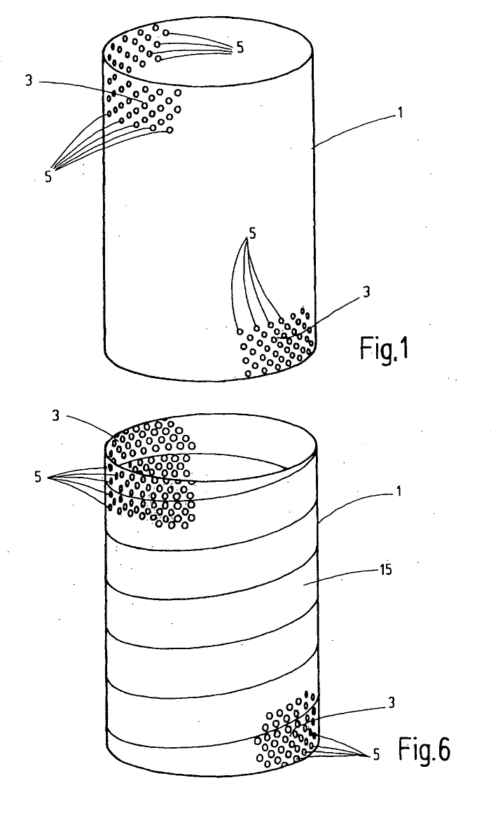

FIG. 1 is a highly simplified perspective view in schematic form of a flat support structure in the form of an outer support tube for a filter element, which, otherwise, is not illustrated;

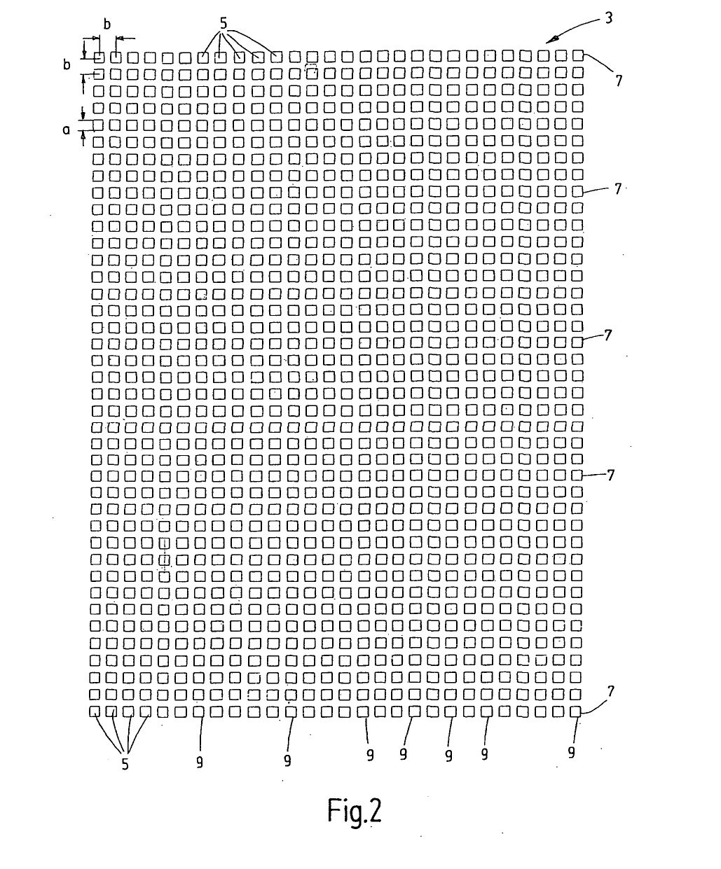

FIG. 2 is a top view of a regular perforation pattern, which has apertures having a square base cross section;

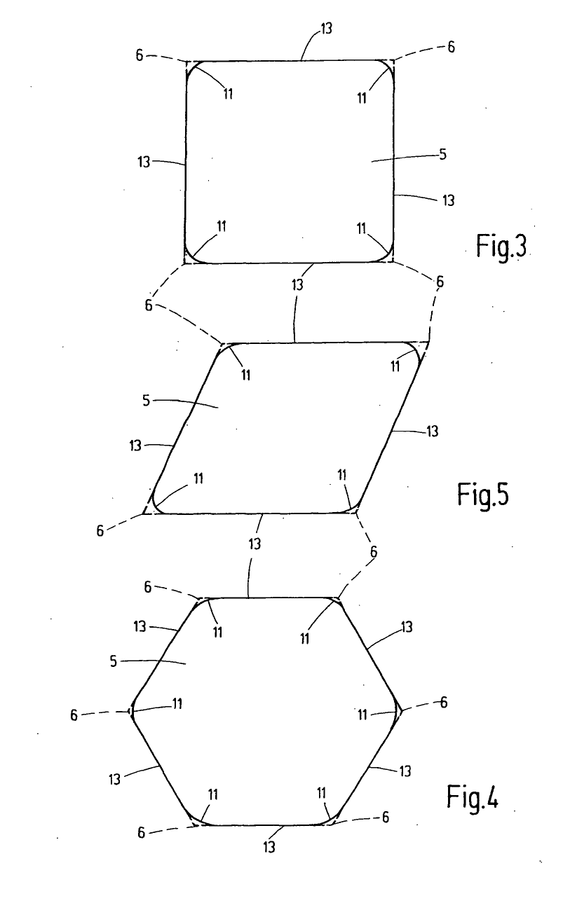

FIG. 3 is a greatly enlarged representation of an aperture having a square base cross section; and this aperture is defined in the corner regions by a curved line, which connects the side lines for a support structure of a filter element according to one exemplary embodiment of the invention;

FIGS. 4 and 5 are representations, corresponding to FIG. 3, of apertures having base cross sections in the form of a hexagon or a parallelogram; and

FIG. 6 is a representation, similar to FIG. 1, of an outer support tube, which is formed from a winding comprising flat support structure members in strip form.

FIG. 1 is a highly simplified representation of a support structure in the form of an outer support tube 1 for a filter element. The support tube 1 surrounds the exterior of a filter medium (not illustrated), which can be constructed in the conventional manner, for example, in the form of a multi-layered filter mat web, which can be folded in the manner of pleats and can be brought into the shape of a cylindrical hollow body. The wall of the support tube 1 forms a through-flow surface, in which the through-flow apertures form a perforation pattern 3 for the passage of fluids. Only some of the perforations 5 of the perforation pattern are indicated and numbered in FIG. 1.

FIG. 2 shows one example of a regular perforation pattern 3 with perforations 5 having a square base cross section in order to form a support tube 1 for one exemplary embodiment of the filter element according to the invention. While FIG. 2 shows very clearly the pattern arrangement of the perforations 5, the inventive, special formation of the corner regions 6 (FIG. 3) of the perforations 5 is not apparent from the drawing in FIG. 2. The special shape of these corner regions 6 can be seen very clearly from the enlarged drawing in FIG. 3.

FIG. 2 shows that the perforation pattern 3 is designed in the form of a regular pattern in such a way that straight lines 7 and straight columns 9, which extend perpendicularly to said straight lines, are formed. In this case, only some of the straight lines and straight columns are numbered. The perforations 5 in the lines 7 and in the columns 9 are evenly spaced apart from each other in each instance; and the perforations 5 exhibit the same shape and dimensions. In the case of the perforation pattern 3, depicted in FIG. 2, the ratio between the length of the sides a and the distance b from the center of adjacent perforations 5 is about 3:5. Such a design offers a good compromise between mechanical strength and fluid permeability. It is self-evident that in cases in which high mechanical strength has a higher ranking than good fluid permeability, other dimensional ratios are suitable, such as in cases where lower flow forces are active at the support structure when the system is running, so that the pattern can be designed, in particular, with respect to the highest fluid permeability possible.

The configuration of the corner regions 6 of the perforations 5 can be seen very clearly in FIG. 3. The side lines 13 do not completely meet, as shown, and, therefore, do not form corner regions 6 exhibiting sharp edges, but rather form defined imaginary corners 6 having a region in which the side lines 13 are connected in each instance by a curved line 11, so that a rounding off is formed in the corner regions 6. This shape results in a material relief at the narrow areas or weak spots during the application of stress by the flow forces. As stated above, said shape also offers advantages during the production of the perforations 5. When the perforations 5 are made by hole punching, the stress applied by the hole punch is extremely high in the corner regions having sharp edges, a feature that leads to a shortened service life of the hole punch, if the objective is to prevent the punched hole contour from fraying at the sharp corner regions 6.

It is very clear from FIGS. 4 and 5 that the invention can also be applied to other polygonal base cross sections of perforations 5. Hence, FIG. 4 shows an example of perforations 5 with a hexagonal base cross section, whereas FIG. 5 shows the inventive configuration of perforations 5 having a base cross section in the shape of a parallelogram.

A support structure exhibiting a perforation pattern 3 that is designed according to the invention allows support tubes 1 to be made as a one-piece module, which substantially surrounds the complete exterior and/or interior of the respective filter material. If it involves filter elements having an especially large format, then a support tube 1, in particular, if it surrounds the exterior of the filter material, can be made in the wound type of construction (illustrated in FIG. 6), in that the whole cylinder of the support tube 1 is constructed from one or more support structure members 15 in strip form. These support structure members overlap slightly at the edges and are fastened to each other at the overlapping point, for example, by flanging, adhesively cementing, welding, soldering, or the like.

The perforation pattern 3 can be made in a number of ways by, for example, laser cutting, etching, or, in the case of materials that lend themselves to hole punching in an advantageous way, punching. A sheet metal, which is corrosion-resistant to the media that are to be filtered, can be used as a material that is suitable for hole punching. In this respect, it can be a hot dip laminated sheet (Zincor®), which can be galvanized, so that the joint points of adjacent structural members 15 can be soldered in a wound type of construction of the support tube 1.

1. A filter element for filtering fluids,
comprising a flat support structure which forms the wall of a support tube (1) which surrounds the exterior and/or the interior of a filter medium and has through-flow apertures (5) forming a perforation pattern (3),
with at least some of the through-flow apertures (5) having a substantially polygonal base cross section,
characterized in that the polygonal base cross section is defined in each instance by a plurality of side lines (13) and a plurality of imaginary corners (6), which are defined in each instance by side lines (13) that extend in pairs toward one another, and
that in the region of the imaginary corners (6) the two corresponding side lines (13) are connected to one another in each instance by a curved line (11).

2. The filter element according to claim 1, characterized in that rectangular, in particular square through-flow apertures (5) are provided in the base cross section.

3. The filter element according to claim 1, characterized in that the through-flow apertures (5) form a perforation pattern (3), in which the through-flow apertures (5) are arranged in straight lines (7) and columns (9), and the through-flow apertures (5) of lines (7) and columns (9) are in alignment with each other.

4. The filter element according to claim 3, characterized in that a regular perforation pattern (3) is provided with through-flow apertures (5) that are arranged in the lines (7) and columns (9) in such a way that they are spaced evenly apart.

5. The filter element according to claim 1, characterized in that in the case of through-flow apertures (5) having a square base cross section, the ratio between the side length (a) and the distance (b) from the center of adjacent through-flow apertures (5) is about 3:5.

6. The filter element according to claim 1, characterized in that the support structure forms a support tube (1) that substantially surrounds the entire exterior and/or the interior of a cylindrical filter material.

7. The filter element according to claim 1, characterized in that a support tube (1), which surrounds the exterior of a cylindrical filter material, is made from a winding consisting of one or more support structure members (15) in strip form.
